(19) United States
(12) Patent Application Publication
(10) Pub. No.: US 2014/0138956 A1
(43) Pub. Date: May 22, 2014

(54) OSMOTIC PRESSURE ELECTRIC POWER GENERATION METHOD, OSMOTIC PRESSURE ELECTRIC POWER GENERATION APPARATUS AND OSMOTIC PRESSURE GENERATOR USED THEREFOR

(71) Applicant: KABUSHIKI KAISHA TOSHIBA, MINATO-KU (JP)

(72) Inventors: Kenji Sano, Tokyo (JP); Arisa Yamada, Kawasaki-shi (JP); Hideyuki Tsuji, Yokohama-shi (JP)

(73) Assignee: KABUSHIKI KAISHA TOSHIBA, MINATO-KU (JP)

(21) Appl. No.: 14/081,185

(22) Filed: Nov. 15, 2013

(30) Foreign Application Priority Data
Nov. 20, 2012 (JP) 2012-254713

(51) Int. Cl. F03B 13/10

(52) U.S. Cl. CPC F03B 13/10
USPC 290/54

(57) ABSTRACT

According to one embodiment, an osmotic pressure power generation method includes the steps of bringing fresh water and salt water to each other while interposing an osmosis membrane, bringing an osmotic pressure inducer into contact with a salt water-side surface of the osmosis membrane to allow the fresh water to permeate at least the osmosis membrane by an osmotic pressure, and rotating a rotor by a water pressure generated by the osmotic pressure, thereby generating power.

### CROSS-REFERENCE TO RELATED APPLICATIONS

This application is based upon and claims the benefit of priority from Japanese Patent Application No. 2012-254713, filed Nov. 20, 2012, the entire contents of which are incorporated herein by reference.

### FIELD

Embodiments described herein relate generally to an osmotic pressure electric power generation method, an osmotic pressure electric power generation apparatus and an osmotic pressure generator used therefore.

### BACKGROUND

Seawater has a salt concentration of about 3.5% on average. When seawater and fresh water are brought into contact with each other via an osmosis membrane (semipermeable membrane) interposed therebetween, an osmotic pressure difference of 25 to 30 atmospheres, although depending on the temperature, is created between both sides of the osmosis membrane with respect to fresh water.

The degree of the osmotic pressure difference, when converted into the potential energy from the osmotic pressure, is equivalent to a height difference of 250 to 300 meters. The basic principle of an osmotic pressure electric power generation apparatus employs a method of generating electric power by rotating a turbine by using the water pressure created by such an osmotic pressure difference. Here, water from sea and river, which is almost limitless in amount, can be used. In the osmotic pressure electric power generation carried out using seawater and fresh water from river, the seawater and fresh water are brought into contact with each other via an osmosis membrane interposed therebetween, and thus a pressure is created on a seawater side, thereby rotating the turbine. With this mechanism, the osmotic pressure electric power generation, unlike the photovoltaic power generation, wind turbine system or the like, is able to generate power continuously 24 hours per day. Further, the osmotic pressure electric power generation is expected as a clean renewable power source which is free of wastes.

The osmotic pressure electric power generation utilizes osmotic pressure, which acts naturally in the direction of a pressure. Therefore, this power generation is also known as the forward osmotic pressure power generation method, and the osmosis membrane employed here is called a forward osmosis membrane (FO membrane).

On the other hand, the desalination of seawater generally requires pressurization using a pump to oppose the osmotic pressure. The osmosis membrane employed here is a reverse osmosis membrane.

The desalination of seawater is called a reverse osmosis desalination method since a pressure is applied in a direction opposite to the osmotic pressure, and the osmosis membrane employed here is called a reverse osmosis membrane (RO membrane).

Unlike the desalination of seawater, the osmotic pressure power generation requires the forward osmosis membrane employed to be highly water permeable in order to increase the power generation efficiency.

However, the conventional osmotic pressure power generation method is not still at a sufficient level in power generation efficiency or not profitable, and therefore the method has not yet been in the actual use.

### BRIEF DESCRIPTION OF THE DRAWINGS

FIG. 1 is a schematic view of an osmotic pressure power generation apparatus of the first embodiment;

FIGS. 2A, 2B and 2C are views of a closed processing container of the second embodiment;

FIGS. 3A, 3B and 3C are views of a closed processing container of the third embodiment;

FIG. 4 is a schematic view of an osmotic pressure power generation apparatus of the fourth embodiment;

FIG. 5 is a schematic view of an osmotic pressure power generation apparatus of the fifth embodiment;

FIG. 6 is a schematic view of another osmotic pressure power generation apparatus of the fifth embodiment;

FIG. 7 is a schematic view of an osmotic pressure power generation apparatus of the sixth embodiment;

FIGS. 8A and 8B are views of a mechanism of an osmotic pressure being created;

FIG. 9 is a graph showing results of Example 1;

FIGS. 10A and 10B are views of a high pressure test device;

FIG. 11 is a view of a test device of Example 3;

FIG. 12 is a view of a state in which an FO membrane and a modified substrate used in Example 4 are in contact with each other;

FIG. 13 is a view of a test device of Example 5; and

FIG. 14 is a graph showing test results in Example 5.

### DETAILED DESCRIPTION

Various embodiments will now be explained with reference to accompanying drawings. Common structural elements throughout the embodiments will be designated by the same reference symbols, and the explanations therefore will not be repeated. Further, each drawing is a schematic diagram to assist readers to easily understand each version thereof, and thus the shapes, dimensions, ratios, etc. illustrated may be different from those of the actual apparatus and may be changed in designing as needed with reference to the following explanations and publicly known techniques.

### First Embodiment

In general, according to first embodiment, an osmotic pressure electric power generation method comprises steps of: bringing fresh water and salt water each other via an osmosis membrane interposed therebetween; bringing an osmotic pressure inducer into contact with a salt water-side surface of the osmosis membrane to allow the fresh water to permeate at least the osmosis membrane by an osmotic pressure; and rotating a rotor by a water pressure generated by the osmotic pressure, thereby generating power. In this manner, the fresh water is made to pass the osmosis membrane at least by the osmotic pressure to create a water pressure, which serves to rotate the rotor, thus generating power.

To be more specific, an osmotic pressure electric power generation method comprises steps of: providing an osmosis membrane having a first surface and a second surface located opposed to the first surface, bringing an osmotic pressure inducer into contact with the second surface of the osmosis membrane, bringing fresh water and salt water into contact with the first surface and the second surface of the osmosis membrane, respectively, to allow the fresh water, which is located a side of the first surface of the osmosis membrane, to permeate at least the osmosis membrane by an osmotic pressure; and rotating a rotor by a water pressure generated by the osmotic pressure, thereby generating power.

Note that the expression “an osmotic pressure inducer is brought into contact with a salt water-side surface of the osmosis membrane” means that an osmotic pressure inducer is brought into contact with an entire salt water-side surface of the osmosis membrane, or that the osmotic pressure inducer is dispersed in the salt water so that a portion of the osmotic pressure inducer is brought into contact with the salt water-side surface of the osmosis membrane. Generally, the former osmotic pressure inducer is used in the form of a membrane, whereas the latter is used in the form of particles.

The above-described method can be carried out with an osmotic pressure power generation apparatus. The apparatus comprises an osmotic pressure generator and a power generator. The osmotic pressure generator comprises an enclosed processing container, an osmosis membrane having a first surface and a second surface located opposed to the first surface and configured to partition an inside of the enclosed processing container into a first chamber faced the first surface of the osmosis membrane and a second chamber faced the second surface of the osmosis membrane, the first chamber being contained fresh water, and the second chamber being contained salt water, an osmotic pressure inducer brought into contact with the second surface of the osmosis membrane, a first inlet formed on a first chamber side of the processing container and configured to flow in the fresh water into the first chamber, a second inlet formed on a second chamber side of the processing container and configured to flow in the salt water into the second chamber, and an outlet formed on a second chamber side of the processing container. The power generator comprises a rotor configured to rotate by flow of the salt water flowing out through the outlet of the processing container.

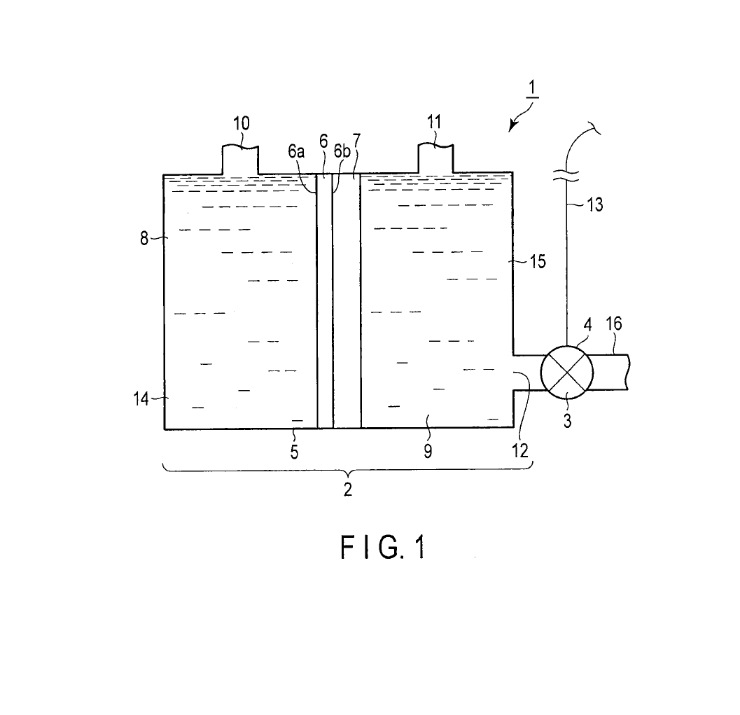

FIG. 1 is a schematic view of an example of the apparatus which carries out the osmotic pressure power generation method. An osmotic pressure power generation apparatus 1 comprises an osmotic pressure generator 2, and a power generator 4 comprising a rotor 3.

The osmotic pressure generator 2 comprises, for example, a horizontal enclosed processing container 5 and an osmosis membrane 6. The osmosis membrane 6 is disposed in the enclosed processing container 5 while the circumference thereof being fixed to an inner wall surface of the container 5. The osmosis membrane 6 has a first surface 6a and a second surface 6b located opposed to the first surface 6a. With this structure, the inside of the enclosed processing container 5 is partitioned horizontally into a first chamber 8 faced the first surface 6a of the osmosis membrane 6 and a second chamber 9 faced the second surface 6b of the osmosis membrane 6 by the osmosis membrane 6. A membrane-like osmotic pressure inducer 7 is in close contact with the second surface 6b (a salt water-side surface) of the osmosis membrane, for example, in its entirety. An upper section of the processing container 5 locating in the first chamber 8 has an opening, which serves as a first inlet 10, whereas an upper section of the processing container 5 locating in the second chamber 9 has an opening, which serves as a second inlet 11. A (right-hand side) sidewall of the processing container 5 locating in the second chamber 9 has another opening, which serves as an outlet 12. The outlet 12 is communicated with a discharge pipe 16, in which the power generator 4 comprising the rotor 3 is intercalated. To the power generator 4, a lead wire 13 is connected to acquire the electricity generated by the generator 4.

The osmotic pressure power generation method is carried out in the following manner. First, water 14 is supplied into the first chamber 8 via the first inlet 10. At the same time or prior to that, salt water 15 is allowed to pass the second inlet 11 and is supplied into the second chamber 9. Thus, the fresh water 14 and salt water 15 are brought into contact with each other via the osmosis membrane 6 and the osmotic pressure inducer 7 interposed therebetween, and thus an osmotic pressure difference is created between the fresh water 14 and salt water 15. Due to the osmotic pressure difference, the fresh water 14 permeates through the osmosis membrane 6 and the osmotic pressure inducer 7. In other words, the fresh water 14 moves from the first chamber 8 to the second chamber 9. As the fresh water 14 moves to the other chamber, the pressure inside the second chamber 9, which is filled with the salt water 15, is increased. As a result, the salt water inside the second chamber 9 flows out from the outlet 12 into the discharge pipe 16. The water pressure of the salt water flown out rotates the rotor 3 intercalated in the discharge pipe 16. The torque of the rotor 3 is converted to electrical power by the power generator 4. The electricity generated is supplied via the lead wire 13 to be used and/or stored in a battery according to the necessity.

In the first embodiment, the osmotic pressure inducer 7 is brought into contact with the osmosis membrane 6 and thus an osmotic pressure is created with respect to the osmosis membrane 6. More specifically, as the osmotic pressure inducer 7 is brought into contact with the salt water side surface of the osmosis membrane 6, a further osmotic pressure is induced with respect to the osmosis membrane 6 by the osmotic pressure inducer 7 in addition to the osmotic pressure difference created due to the difference between the fresh water and salt water in salt concentration. Thus, fresh water moves from the first chamber to the second chamber filled with the salt water in more amount than the conventional cases, thereby making it possible to generate power at a higher efficiency.

The osmotic pressure inducer 7 is a functional group-bonded base material, that is, a modified base material. The functional group-bonded based material should preferably be of such a type that the functional group bond to the base material without being released therefrom even when the material is brought into contact with water.

The functional group may be of any type as long as it is capable of creating an osmotic pressure with respect to the osmosis membrane 6. Such a functional group may form, for example, a salt structure together with a counter ion, or may be a sugar or the like, which does not form a salt structure. An example of a preferable functional group is a group originated from the silane coupling agent.

The group originated from the silane coupling agent may be of any type as long as it is a functional group obtained when bonding the functional group to the base material, for example, by the silane coupling process which using the silane coupling agent.

The silane coupling process is a process in which, for example, a silane coupling agent is introduced to a base material. The silane coupling agent may be of any type as long as, for example, a structure having a high affinity to water is introduced to a substituent consisting of a carbon atom directly bonded to silane. Examples of the structure having a high affinity to water are —OH, —NH₂, NH—, —N═, —NH₃⁺, —NH²⁺, and ═N⁺═.

Examples of the silane coupling agent are N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, N-2-(aminoethyl)-3-aminopropyltriethoxysilane, 3-triethoxysilyl-N-(1,3-dimethyl-butylidene)propylamine, N-phenyl-3-aminopropyltrimethoxysilane, N-(vinylbenzyl)-2-aminoethyl-3-aminopropyltrimethoxysilane, (3-ureidopropyl)trimethoxysilane, (3-ureidopropyl)triethoxysilane and trimethyl[3-(triethoxysiliyl)propyl]ammonium chloride. These materials may be in the form of a salt structure and/or complex structure as they form together with an acid, a base or some other counter ion.

The introduction rate of the silane coupling agent to the base material may be 5 to 60% on an assumption that, for example, the base material is not pressure loss, and should more preferably be 60 to 80%. Here, the definition of the “silane coupling agent introduction rate” is the bonding rate of the silane coupling agent introduced to the OH group of the modified material in terms of the number of moles. However, in the case where filter paper or the like is used as the base material, the water flow channel serves an important role; therefore an excessive introduction causes the blocking of the flow channel, creating even an adverse effect.

The modified base material, which is the osmotic pressure inducer 7, should be brought into (close) contact with the osmosis member 6 simply only in such a manner that the pores of both of the osmosis membrane and the modified based material, through which liquid passes, are not blocked. The osmosis membrane and the modified based material may be sent in close contact with each other, for example, by simply attaching to each other under a high pressure. Alternatively, they may be held tight together with a supporting member such as a frame, or using a net or some other structure. Further, the peripheral portions of the membrane and the based material, which do not serve a role of the flow channel, may be fused together by hot-melt or adhered to each other using an adhesive.

Further, when modified base material, which is the osmotic pressure inducer 7, should be brought into (close) contact with the osmosis member 6, it is preferable that the base material should be disposed on the active layer side of the osmosis member 6. The “active layer” of the osmosis member 6 is an active membrane portion of the osmosis membrane 6, which serves the function of desalination. Here, the osmosis membrane 6 is of the Loeb and Sourirajan type, or asymmetrical type. The active layer has a thickness of, usually, 0.1 to 1 μm, and formed on the osmosis membrane 6. The portion of the osmosis membrane 6 other than the active layer is called a “support layer”.

In the osmotic pressure power generation method of the first embodiment, the salt water may be, for example, sea water and/or industrial waste water having a high salt concentration. The salt concentration of the salt water employed here may be sufficient at, for example, 0.05 to 4%, but should preferably be as high as possible.

The osmosis membrane 6 may be of any type as long as it is a membrane generally employed as a desalting membrane, and examples thereof are a cellulose acetate membrane and a polyamide membrane. The desalting membrane should preferably have a thickness of 45 to 250 μm. The osmosis membrane 6 may be a forward osmosis membrane or a reverse osmosis membrane, though the forward osmosis membrane is preferable.

Examples of the base material are paper, cotton, cupro, rayon, cellulose membrane such as of cupro-ammonium rayon, fabric and resin film. Of these, a soft paper such as filter paper or unwoven fabric is preferable since it is capable of preventing the desalting membrane from being damaged under a pressure. Further, in order to suppress the pressure loss as much as possible, it is preferable that the base material should comprise a material with a higher water permeability as possible. The thickness of the base material 4 should preferably be, for example, 1 to 100 μm.

The base material employed in the osmotic pressure induction is, as mentioned above, brought into contact with a part of or an entire water-side surface of the osmosis membrane, or that the osmotic pressure inducer is dispersed in the salt water so that a portion of the osmotic pressure inducer is brought into contact with the salt water-side surface of the osmosis membrane. Note that the base material may be in such a form of a singular or a plurality of fabrics, or particles. In the case of fabric, regardless of singular or plural, it may be of a cellulose membrane, fabric or a fragment of resin film, or a fabric material that is obtained by dissolving these.

The particulate base material may be of, for example, an inorganic particle or resin particle. The inorganic particle may be a metal oxide or a half-metal oxide such as silica (SiO₂), titania (TiO₂), alumina (Al₂O₃) and/or zirconia (ZrO₂), etc. The reaction between the coupling agent and the inorganic particle proceeds as the hydroxyl group present on the surface of the inorganic particle reacts with the coupling agent. Therefore, of those metal oxides and semi-metal oxides, silica is particularly preferable since it has a great number of hydroxyl groups on its surface.

There are several examples for the reaction between the coupling agent and the inorganic particle, some of which are that is, the coupling agent is gasified to react with the particle, the coupling agent is mixed into a solvent to be blended with the inorganic particle and the particle and the coupling agent are made to react with each other without using a solvent. Any one of these methods may be employed. In the reaction of any of these, heating or depressurization may be carried out in order to adjust the amount of modification. As a solvent, such a type that can decompose the reaction material, as an organic solvent or water, is not preferable. In terms of reaction conditions including the operating temperature, ethanol and/or water, for example, are preferable due to have good operability. It is also preferable that the ratio between the coupling agent and the inorganic particle should be adjusted to such a degree that some of the hydroxyl groups remain on the surface of the inorganic particle. For example, the coupling process should be carried out preferably with a coupling agent at a ratio of 20% by weight or more but 150% by weight or less with respect to the inorganic particle. Alternatively, a dispersion stabilizer may be used for the coupling agent. For example, an alcohol such as ethanol may be used as the dispersion stabilizer.

The resin particle may be of any type as long as it is capable of introducing the silane coupling agent thereto, and examples thereof are polyvinyl alcohol, cellulose, processed cellulose and polyacrylic acid.

The average particle diameter of the particulate base material should be 100 μm or more but 5000 μm or less. With the average particle diameter of the particles being set to 100 μm to 5000 μm, excellent properties can be obtained in terms of both of the filling factor with respect to the osmotic pressure generator and the water permeability. Note that, for example, when the average particle diameter is less than 100 μm, a high filling factor can be obtained, but the water permeability is low. On the other hand, for example, when the average particle diameter exceeds 5000 μm, a high water permeability can be obtained, but the filling factor is low. A preferable average particle diameter is 100 μm or more but 2 mm or less, and more preferably it should be 300 μm or more but 1 mm or less.

Here, the average particle diameter can be measured by a sieving method. More specifically, according to JISZ8901₂₀₀₆, “Test Powder and Test Particle”, the measurement can be performed by sieving the particles using a plurality of sieves of one opening size ranged from 100 μm to 5000 μm.

In the case where the granulated base material or fabric modified material is partially brought into contact with the salt water-side surface of the osmosis membrane, it is estimated that the material should only cover 80 to 95% of the area of the osmosis membrane.

The size of the particulate or fabric base material thus arranged may be 0.01 to 5 mm, or more preferably, 1 to 5 mm.

In the first embodiment, the membrane-like modified base material, which is the osmotic pressure inducer 7, may be brought into contact with the second chamber-side surface of the osmosis membrane in its entirety. Alternatively, when a particulate modified base material as the osmotic pressure inducer 7 is employed, the material may be dispersed in salt water in the second chamber side such as to bring some of the particulate modified base material into contact with the osmosis membrane-side surface, or the osmosis membrane-side surface partially.

In the case where the particulate modified material, which is the osmotic pressure inducer 7, is disposed in the salt water 15 contained the second chamber 9, it is preferable that a filter or the like should be employed to remove the particulate osmotic pressure inducer 7 from the salt water allowed to flow out through the outlet 12. Such a filter may be disposed on the wall surface of the enclosed processing container 5 while fixing the peripheral portion thereof to the wall surface such as to cover the outlet 12. Further, the filter may be disposed vertically to an axis of the discharge pipe 16 situated between the outlet 12 and the rotor 3.

Although the first embodiment described above provides an example in which the hollow rectangular closed processing container 5 is used, the shape of the processing container 5 is not limited to a rectangular, but may be various hollow shapes such as cylinder, cone, prism and pyramid.

The enclosed processing container 5 is composed of a material appropriate for containing water or salt water. For example, the container may be formed a desired shape made of, for example, resin, metal, glass and/or a composite material of these in any combination.

The first embodiment described above provides an example of a horizontal type of the processing container 5 in which the first chamber 8 and the second chamber 9 are disposed in a parallel direction with respect to the installation surface. But, the closed processing container 5 may be of a horizontal type. For example, in the case of the vertical processing container 5, the osmosis membrane is disposed vertically to the direction of gravity, and the second chamber is located on an upper or lower side. It is preferable that the second chamber 9 is located on an upper side. The first chamber 8 and the second chamber 9 may be disposed at some other positions. For example, the first chamber 8 and the second chamber 9 may be disposed to be adjacent to each other while interposing the osmosis membrane 6 therebetween and at different levels with respect to the installation surface of the container. The locations of the first inlet 10, the second inlet 11 and the outlet 12 are not limited to those described in the first embodiment.

The power generator comprising the rotor 3 is configured to convert a water pressure to electrical power, where the water pressure is created by the force of the salt water which flows out through the outlet 12 of the second chamber 9. The rotor 3 is rotated by the water pressure, and the torque of the rotation generates electricity. The rotor may be, for example, a water wheel or turbine.

### Second Embodiment

The second embodiment provides an osmotic pressure element as the osmotic pressure generator 2. The osmotic pressure element is an osmotic pressure generator having a volume of about 1 to about 20 L. A plurality of such osmotic pressure elements are assembled together as an osmotic pressure module to output pressures generated by the osmotic pressure elements as one total pressure. In the case of the osmotic pressure module, it is possible to replace only degraded ones of the osmotic pressure elements which may degrade by use.

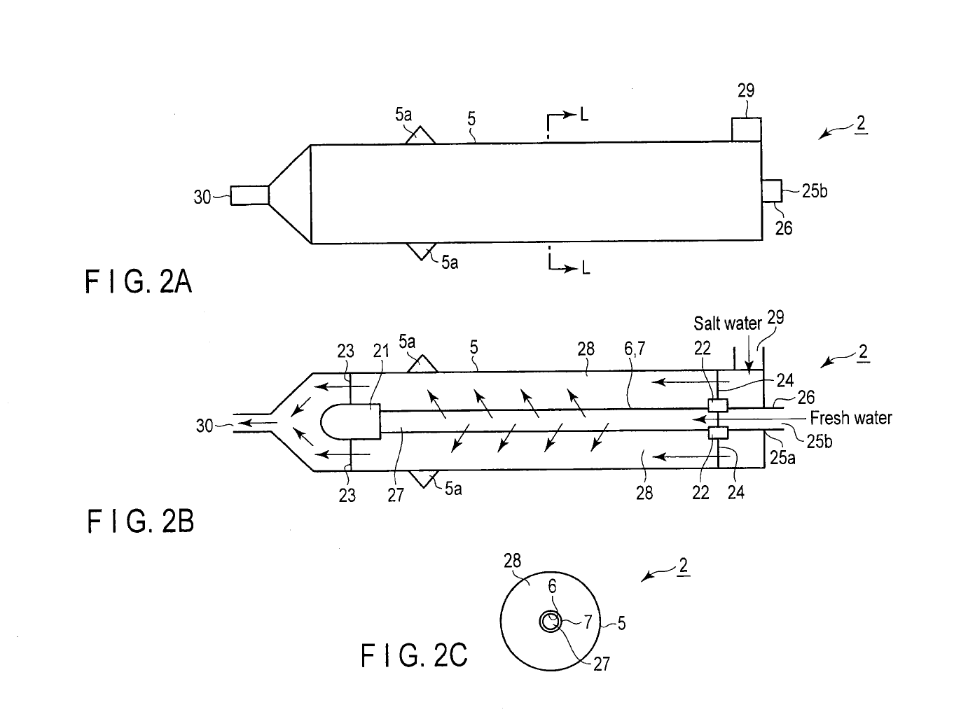

An example of the osmotic pressure generator 2 provided as an osmotic pressure element will now be described with reference to FIG. 2.

FIG. 2A is a side view of the osmotic pressure generator 2. FIG. 2B shows a longitudinal section of the osmotic pressure generator 2 and FIG. 2C shows a cross section taken along the line L-L.

The osmotic pressure generator 2 comprises a cylindrical enclosed processing container 5. The container 5 comprises projections 5a on an outer side thereof so as to be fixed to a support member such as a table, rack, base or tower. In order to fix the container 5 to the support member, the projections 5a may be held in with, for example, a spring structure provided on the support member. As the container 5 is fixed to the support member, a generated pressure can be efficiently utilized.

The enclosed processing container 5 comprises one end (the right end), which is sealed, and an opening 25a at a center thereof. A nozzle 26 comprises a distal end and an opening 25b at another end. The distal end of the nozzle 26 is inserted to the opening 25a shown on the right-hand side end of the container 5, whereas the other end is extended to an outside. As to the container 5, a tapered-down portion is formed in the other end (the left-hand side end) and a distal end of the tapered portion is opened as an outlet 30 to allow the liquid to flow out. Further, an inlet 29 is provided in the vicinity of the right-hand end of the container 5.

Inside the container 5, a cylindrical osmosis membrane 6 and an osmotic pressure inducer 7 are concentrically arranged to be integrated with each other. An end (right-hand side end) of an integrated set of the cylindrical osmosis membrane 6 and the osmotic pressure inducer 7 are connected by abutting to the distal end of the nozzle 26, which is located inside the enclosed processing container 5. The set of the osmosis membrane 6 and the osmotic pressure inducer 7 and the nozzle 26 are fixed to each other with a ring-shaped holder 22 mounted on an inner wall surface of the container 5 via a support plate 24. The other end portion (left-hand side end side) of the set of the osmosis membrane 6 and the osmotic pressure inducer 7, which is located on the tapered portion side of the processing container 5, is fittingly covered with a cap 21 mounted on the inner wall surface of the container 5 via a support plate 23. Thus, the opening of its left-hand side end is closed. The support plates 23 and 24 each have such a structure that a plurality of support pieces are radially coupled with each other between an inner ring and an outer ring, and thus the liquid is allowed to flow through gaps between the support pieces. As shown in FIG. 2C, the osmotic pressure inducer 7 is a membrane which covers an outer circumferential surface of the cylindrical osmosis membrane as it is brought into contact thereon.

As described above, the cylindrical osmosis membrane 6 and the osmotic pressure inducer 7 are coaxially arranged inside the enclosed processing container 5. With this structure, the first chamber 27 is formed inside the osmosis membrane 6, and the second chamber 28 is formed between the osmotic pressure inducer 7 and the enclosed processing container 5. The fresh water is supplied into the first chamber 27 via the opening 25b of the nozzle 26 projecting from the right-hand side end of the container 5. The salt water is supplied into the second chamber 28 via the inlet 29 provided in the vicinity of the right-hand side end of the container 5, and is allowed to flow out from the outlet 30 on the left-hand side.

The osmotic pressure is generated by the osmotic pressure generator 2 in the following manner. That is, fresh water is supplied into the first chamber 27 via the nozzle 26, and salt water into the second chamber 28 via the inlet 29. The fresh water in the first chamber 27 permeates through the osmosis membrane 6 and the osmotic pressure inducer 7 due to the osmotic pressure promoted by the osmotic pressure inducer 7, and thus moves to the second chamber 27. The water pressure created by the movement of the fresh water forces the salt water in the second chamber 28 discharge from the outlet 30. Thus, the power is generated by utilizing the pressure created by the water flowing out of the outlet 29.

### Third Embodiment

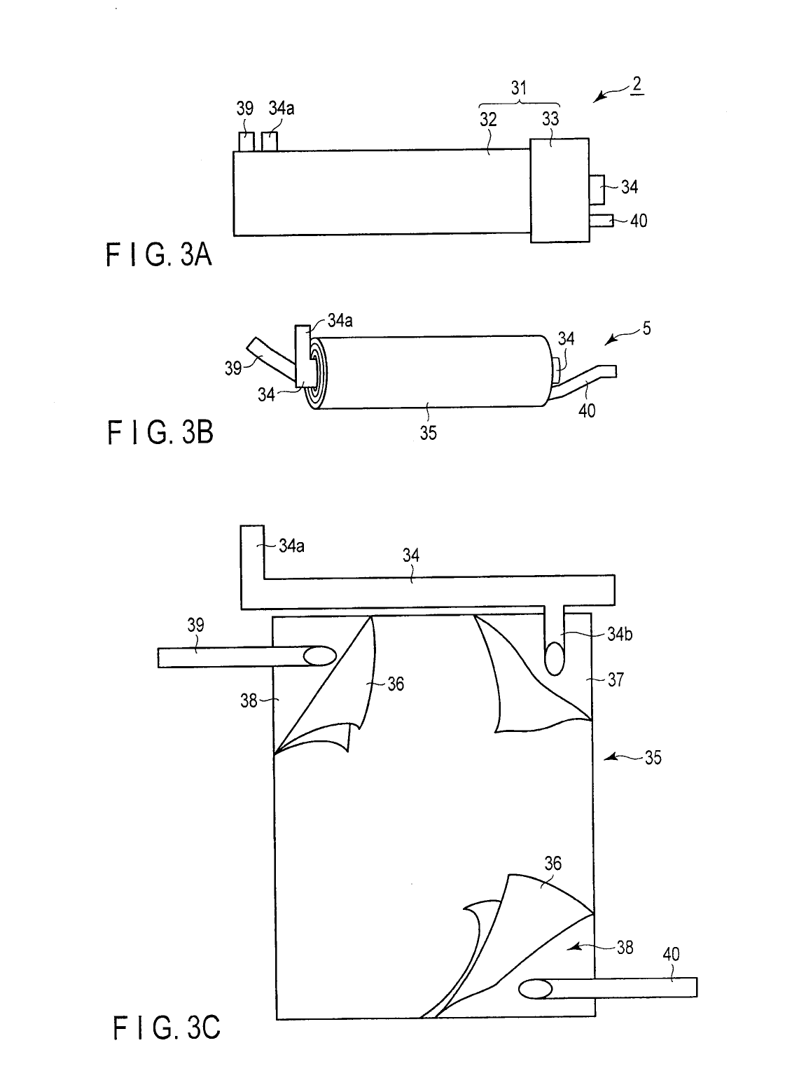

An osmotic pressure generator 2 provided as an osmotic pressure element will now be described with reference to FIG. 3.

FIG. 3A is a side view of the osmotic pressure generator 2. FIG. 3B is a side view of an enclosed processing container 5 housed in a housing 31. FIG. 3C is a developed schematic view of the enclosed processing container 5 shown in FIG. 3B.

The osmotic pressure generator 2 comprises a hollow cylindrical housing 31 and an enclosed processing container 5 housed in a housing 31. The housing 31 comprises a left-hand end-closed cylindrical main body 32 and a cap 33 fittingly set on an opening right-hand side end of the cylindrical main body 32.

The enclosed processing container 5 has such a structure that a liquid container 35 is wound around a hollow rod member 39. The hollow rod member 34 is formed of, for example, a synthetic resin, to comprise a first inlet 34a configured to supply fresh water to the vicinity of the left-hand side end and a first outlet 34b configured to allow the fresh water to the vicinity of the right-hand side end, which are integrated with each other. The first inlet 34a and the first outlet 34b are each made of a thin-film tube of a synthetic resin.

The liquid container 35 comprises two flat bags formed by attaching three pieces of film by the circumferential edges thereof, and the second film functions as a permeable membrane 36 of the two flat bags. The permeable membrane 36 is formed of stacked films of an osmosis membrane and a membrane-like osmotic pressure inducer. An inside of a first bag, which is located on the osmosis membrane side with respect to the permeable membrane 36, functions as a first chamber 37. An inside of a second bag, which is located on the osmotic pressure inducer side with respect to the permeable membrane 36, functions as a second chamber 38.

In the structure in which the liquid container 35 is wound around the hollow rod member 34, the outlet 34b of the hollow rod member 34 is inserted to the first chamber 37 located on the right-hand side of the first flat bag. The second inlet (second inlet tube) 39 configured to supply salt water is inserted to the second chamber 38 located on the left-hand side of the second flat bag and the second outlet (second outlet tube) 40 configured to output the salt water is inserted to the second chamber 38 located on the right-hand side of the second flat bag.

The first inlet 34a of the hollow rod member 34 is extended to the outside through the vicinity of the left-hand side end of the housing 31. The second inlet tube 39 is extended to the outside through the vicinity of the left-hand side end of the housing 31. The second outlet tube 40 is extended to the outside through the cap 33 of the housing 31.

The osmotic pressure is generated by the osmotic pressure generator 2 in the following manner. That is, fresh water is supplied into the first chamber 37 via the first inlet 34a of the hollow rod member 34, the hollow rod member 34 itself and the first outlet 34b. Salt water is supplied into the second chamber 38 via the second inlet 39. The fresh water in the first chamber 37 permeates through the permeable membrane 36 due to the osmotic pressure promoted by one membrane-like osmotic pressure inducer which forms the permeable membrane 36, and thus moves to the second chamber 38. The water pressure created by the movement of the fresh water forces the salt water to flow out from the second outlet 40. Thus, the power is generated by utilizing the pressure created by the water flowing out of the second outlet 40.

In the osmotic pressure generator 2, the liquid container 35 comprises two flat bags formed by attaching three pieces of film by the circumferential edges thereof. Further, the second film is formed to function as a permeable membrane 36 of the two flat bags, and the insides of the first and second flat bags are used as the first chamber 37 and the second chamber 38, respectively. With this structure, the area of the osmosis membrane and the membrane-like osmotic pressure inducer, which form the permeable membrane 36 can be increased while the dimensions thereof being kept compact, and therefore the pressure of the water flowing out from the second outlet 40 can be further increased.

### Fourth Embodiment

In general according to fourth embodiment, an osmotic pressure power generation apparatus comprises an osmotic pressure generator, a storage tank and a power generator. The osmotic pressure generator comprises an enclosed processing container, an osmosis membrane configured to partition an inside of the enclosed processing container into a first chamber and a second chamber, the first chamber being contained fresh water, and the second chamber being contained salt water, an osmotic pressure inducer brought into contact with a surface of the osmosis membrane, located on the second chamber side, a first inlet formed on a first chamber side of the processing container and configured to flow in the fresh water into the first chamber, a second inlet formed on a second chamber side of the processing container and configured to flow in the salt water into the second chamber, and an outlet formed on a second chamber side of the processing container. The storage tank is connected to the first outlet of the processing container and comprising a second outlet. In addition, the storage tank is configured to contain salt water flowing out through the first outlet. The power generator comprises a rotor configured to rotate by flow of the salt water flowing out through the second outlet of the storage tank.

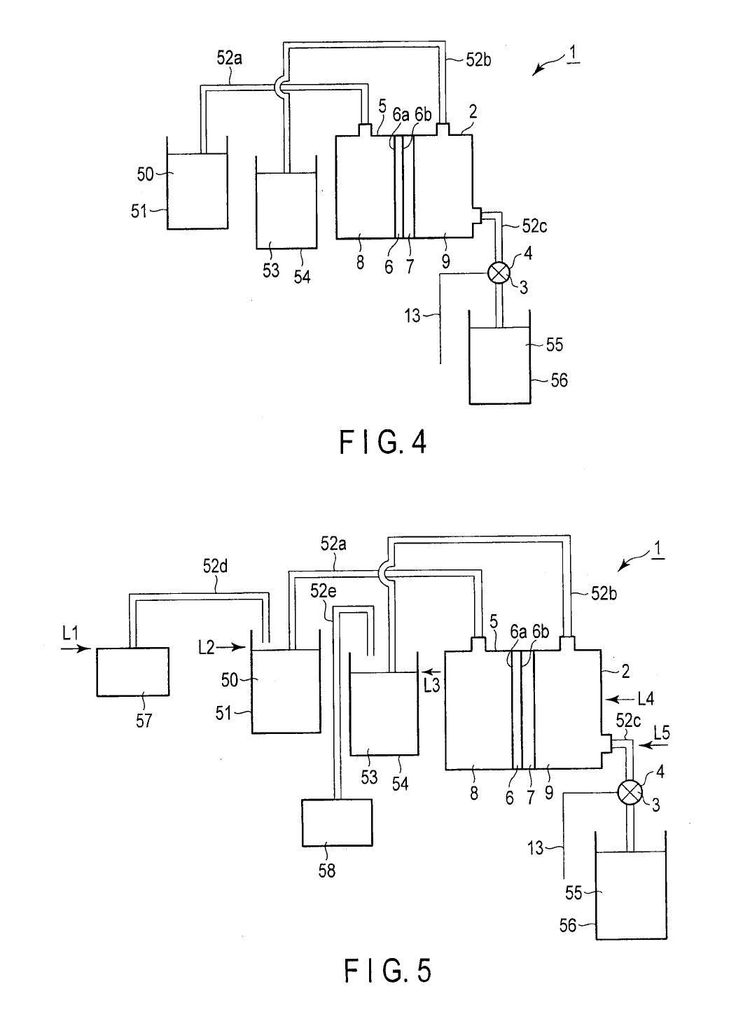

The fourth embodiment will now be explained a detail description with reference to FIG. 4. FIG. 4 is a schematic view of an example of an apparatus configured to carry out the osmotic pressure power generation method. An osmotic pressure power generation apparatus 1 comprises an osmotic pressure generator 2, a power generator 4 comprising a rotor 3, and a lead wire 13 as in the case of the first embodiment, and further a first storage tank 51 configured to contain fresh water 50 to be supplied to a first chamber 8 and a second storage tank 54 configured to contain salt water 53 to be supplied to a second chamber 9. The first storage tank 51 is connected to a first inlet 10 via a pipeline 52a through which the fresh water is allowed to pass. Similarly, the second storage tank 54 is connected to a second inlet 11 via a pipeline 52b in which the salt water is allowed to pass.

It is also possible that the fourth embodiment further comprises a third storage tank 56. In this alternative version, the salt water is allowed to flow out from an outlet 12 of the second chamber 9 via a pipeline 52c, and thus a rotor 4 intercalated in the pipeline 52c is rotated to generate electrical power.

After that, the salt water 53 is collected and stored in the third storage tank 56.

### Fifth Embodiment

The fifth embodiment will now be described with reference to FIG. 5. FIG. 5 is a schematic view of an example of an apparatus configured to carry out the osmotic pressure power generation method.

An osmotic pressure power generation apparatus 1 further comprises, in addition to those of the fourth embodiment, a pipeline 52d configured to supply fresh water to a first storage tank 51 and a pipeline 52e configured to supply salt water to a second storage tank 54. The pipeline 52d is configured to supply fresh water to the first storage tank 51 from a fresh water supply source 57 such as a river. For example, when the fresh water is collected from a river, an end of the pipeline 52d may be placed in the river. The pipeline 52e is configured to supply salt water and/or industrial waste water to the second storage tank 54 from a salt water supply source 58 such as sea and/or a factory. When the salt water is collected from sea, an end of the pipeline 52e may be placed in the sea. Or, when industrial waste water is used as the salt water, it suffices if the end of the pipeline 52e is connected to a storage tank of industrial waste water or to an outlet to discharge the waste water.

It is alternatively possible that a filter is disposed between the fresh water supply source 57 and the first storage tank 51, and/or between the salt water supply source 58 and the second storage tank 54.

Some of the containers of the osmotic pressure power generation apparatus 1 should preferably be disposed such that the level of the liquid contained in each container becomes as follows. The water level (L2) of fresh water 50 contained in the first storage tank 51 is equal to an average level (L1) of the river. The water level (L3) of salt water 55 contained in the second storage tank 54 and the position (L4) of the outlet to discharge the salt water from the second chamber of the osmotic pressure generator 2 are lower than the average level (L1) of the river.

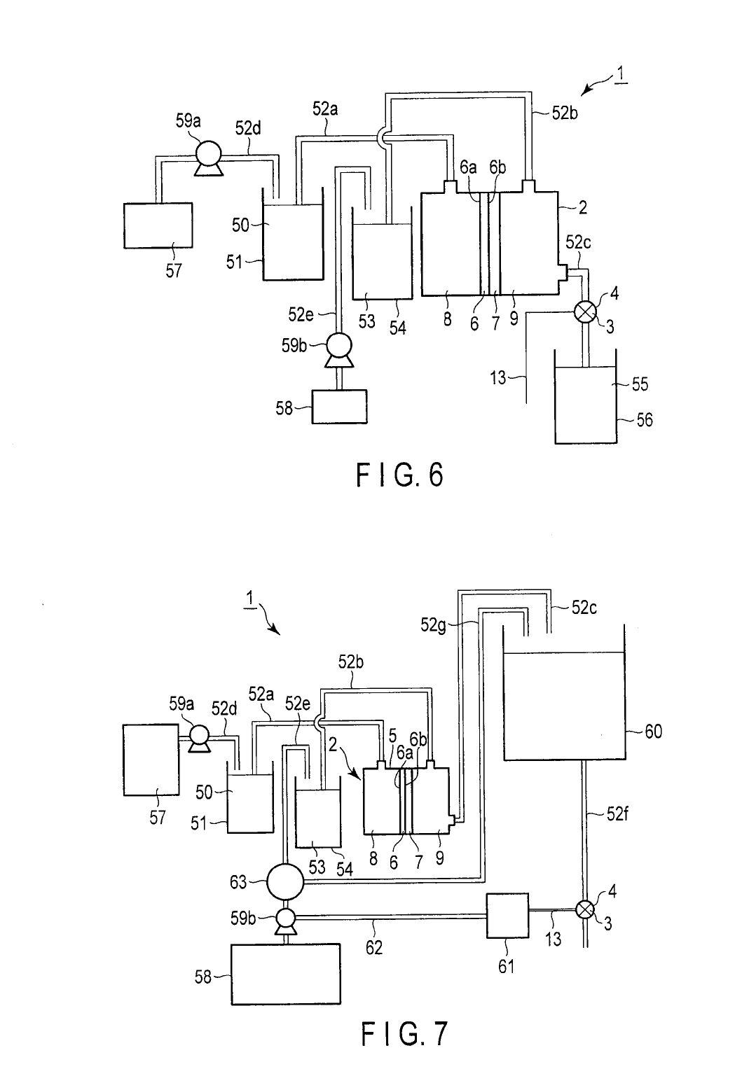

With the above-described arrangement, the osmotic pressure power generation can be performed efficiently. Another version of the fifth embodiment will now be described with reference to FIG. 6. In this alternative version, a pump 59a is intercalated in the pipeline 52d disposed between the first storage tank 51 and the river, and a pump 59b is intercalated in the pipeline 52e disposed between the second storage tank 54 and the sea and/or the salt water supply source 58.

In the fifth embodiment, the osmotic pressure power generation apparatus 1 may take such a structure that the electricity generated by the power generator 4 is accumulated in a battery (not shown) via the lead wire 13. Further, the osmotic pressure power generation apparatus 1 may comprise a plurality of lead wires 13 to use and store the electricity generated by the power generator 4. For example, the osmotic pressure power generation apparatus 1 may comprise a lead wire configured to directly use the electricity generated by the power generator 4 and a lead wire to be connected to a battery for the accumulation of the electricity.

### Sixth Embodiment

The sixth embodiment will now be described with reference to FIG. 7. In this embodiment, an osmotic pressure power generation apparatus 1 is used in combination with pumped-storage power generation.

The osmotic pressure power generation apparatus 1 further comprises a fourth storage tank 60 used for pumped-storage power generation. In the fourth storage tank 60, a pipeline 52c configured to discharge salt water from a second chamber 9 of an osmotic pressure power generator 2 is connected to the fourth storage tank 60. The fourth storage tank 60 is set higher than the osmotic pressure power generator 2. Salt water discharged from the second chamber 9 of the osmotic pressure power generator 2 is supplied into the fourth storage tank 60 by utilizing the water pressure due to the osmotic pressure created in the osmotic pressure power generator 2. A pipeline 52f is extended downwards from the fourth storage tank 60, and a rotor 3 intercalated therein to form a power generator 4. The power is generated by the power generator 4 as the rotor 3 is rotated.

In order to be used in combination with such a pumped-storage power generation system, it suffices if the osmotic pressure power generation apparatus 1 comprises an osmotic pressure power generator 2, a storage tank 60 configured to contain salt water discharged from a first outlet of the osmotic pressure power generator 2 via a pipeline 52c, and a power generator 4 further comprising a rotor 3 intercalated in a pipeline 52f and configured to be rotated by flow of the salt water discharged from the outlet of the storage tank 60 via the pipeline 52f.

The electricity generated by the power generator 4 may be used and/or accumulated via a lead wire 13 connected to the power generator 4. Further, the osmotic pressure power generation apparatus 1 may comprise a plurality of lead wires 13.

The osmotic pressure power generation apparatus 1 may comprise a battery connected via the lead wire 13 to the power generator 4. The electricity generated by the power generator 4 may be accumulated in a battery 61 via the lead wire 13. Further, it is possible that the battery 61 is connected to a pump 59b via a lead wire 62 and the electricity accumulated in the battery 61 is used as the power for the pump 59b to pump up salt water from a salt water supply source 58 of seawater and/or factory waste into the second storage tank 54.

The pumping-up to the fourth storage tank 60 may be carried out by supply of salt water by the osmotic pressure generator 2 and also supply of salt water directly from the salt water supply source in combination. Alternatively, the pumping-up to the fourth storage tank 60 may be carried out by switching between the supply of salt water by the osmotic pressure generator 2 and the supply of salt water directly from the salt water supply source selectively. In this case, a flow-channel switch valve (for example, three-way valve) 63 may be intercalated in the pipeline 52e between the salt water supply source 58 and the second storage tank 54 so as to supply the salt water of the salt water supply source 58 to the fourth storage tank 60 via the three-way valve 63 and a pipeline 52g.

In the case where sea is the salt water supply source 58, the pumping-up to the fourth storage tank 60 by the osmotic pressure generator 2 should preferably be carried out when the sea is at high tides. The pumping-up at high tides is advantageous because the difference in level between the sea and the fourth storage tank 60 is smaller. For example, at the seashore of Onahama Beach, there is a difference of 60 cm between the high tide and low tide in the variation in sea level in a day. It is not desirable to carry out the pumping-up at low tides, whereas it is preferable that the pumping-up be carried out at high tides. In this manner, the loss of energy can be suppressed, and the power generation efficiency can be improved.

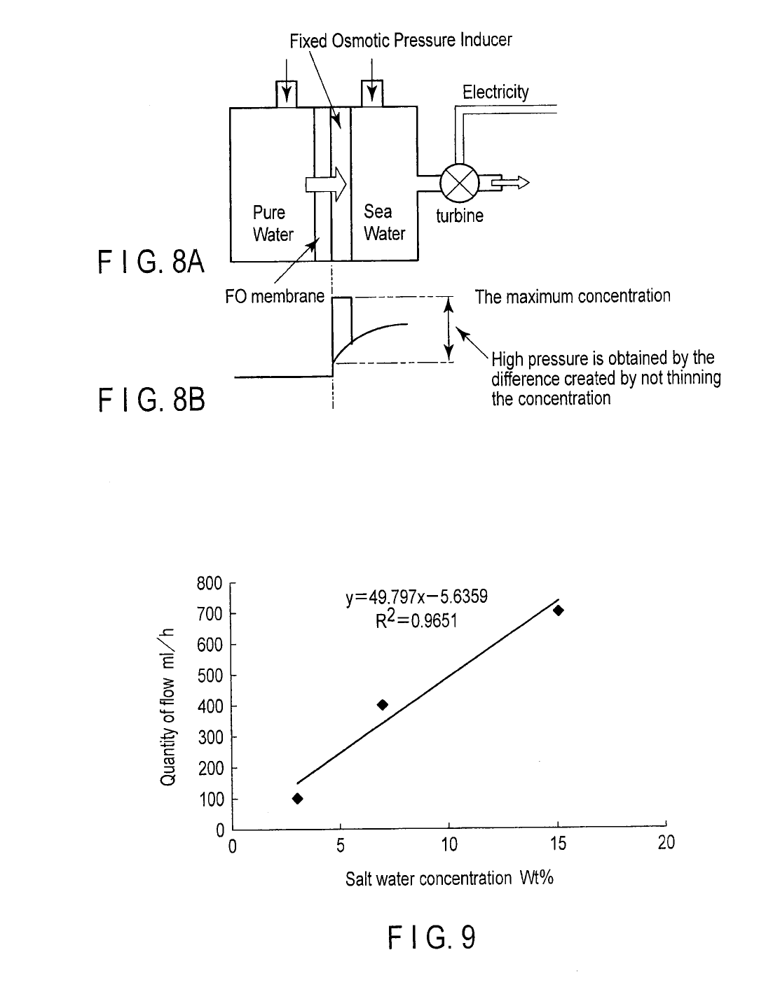

The osmotic pressure power generation apparatus according to the first to sixth embodiments are used in methods which utilizes water pressure created by an osmotic pressure power generator for the power generation. In the osmotic pressure generator 2, fresh water is brought into contact with salt water while interposing therebetween an osmosis membrane and an osmotic pressure inducer arranged in this order as shown in FIG. 8A. FIG. 8B is a graph of the salt concentration in the osmotic pressure generator, with the location in the osmotic pressure generator plotted in the abscissa axis and the degree of salt concentration at each location in the ordinate axis. When the osmotic pressure inducer is provided, the dilution of the salt water by salt water permeating through the osmosis membrane and osmotic pressure inducer to flow therein can be suppressed. In this manner, it becomes possible to perform the power generation efficiently and persistent.

### EXAMPLE 1

With use of an element (CSM RE2012-100: a product of Woongjin of Korea) as the osmotic pressure generator, the quantity of flow of the liquid following therein was measured. This element is an apparatus comprising a forward osmosis (FO) membrane configured to desalting seawater. Here, salt water was injected from the inlet of the element, where originally seawater is supposed to be injected, and fresh water was injected to the outlet, where originally fresh water is supposed to be collected. Thus, the volume of the liquid output from the outlet was measured. The salt concentration of the salt water supplied was varied as 3.5% by weight, 7% by weight and 15% by weight.

The results are shown in FIG. 9. The abscissa axis of the graph shown in FIG. 9 indicates the salt concentration of the salt water supplied, whereas the ordinate axis indicates the quantity of flow from the outlet.

As the salt concentration was increased, the quantity of flow increased as well. From this reason, it was clarified that a higher water pressure could be obtained because the salt concentration on the salt water side of the FO membrane became higher. For example, as compared to, for example, the salt water having a salt concentration of 3.5%, nearly 4 times as much as the quantity of flow can be obtained when the osmotic pressure inducer is disposed on the salt water side such as to achieve 7% of salt concentration. In this manner, a higher water pressure can be obtained.

### EXAMPLE 2

A modified base material was prepared by modifying filter paper with a silane coupling agent. More specifically, 0.1 g of silane coupling agent (3-(2-aminoethylamino)propyltrimethoxysilane), 2 g of water and 8 g of EtOH were mixed together, and a filter paper product (No. 5A (trapping 7 μm-particles) of Kiriyama Glass, Co.) having a diameter of 45 mm, was immersed in the mixture. The resultant was let stand for 2 hours at room temperature. Subsequently, the mixture solution in the resultant was vaporized at 40° C. and then further heated at 110° C. for 2 hours. After that, the resultant was washed well with water, and then treated with 1N hydrochloric acid for 5 minutes. Furthermore, the resultant was washed well with water and subjected to ultrasonic washing in the water for 9 minutes. Then, it was washed with water and dried. The thus obtained filter paper was placed in a high-pressure test apparatus.

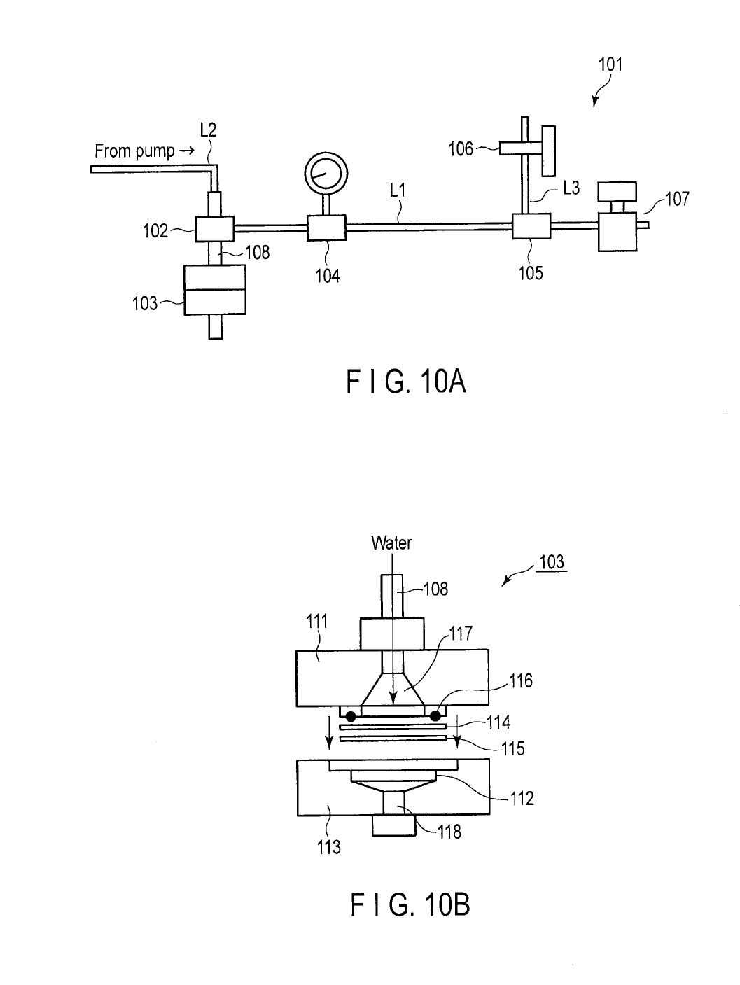

FIG. 10A shows a high-pressure test apparatus used in the high-pressure test. A test device 101 comprises a main first pipe L1. A first connector 102 is attached to a left end of the first pipe L1. A cell 103 is connected to the first connector 102 via an introduction pipe 108. A second pipe L2 is connected to the introduction pipe 108 and a pump (not shown) is attached to an end of the second pipe L2. A second connector 105 is mounted to a vicinity of the right end of the first pipe L1. A pressure gauge 104 is attached to the first pipe L1 between the first and second connectors 102 and 105. A third pipe L3 is connected to the second connector 105, and a first pressure-releasing valve 106 is attached to the third pipe L3. A second pressure release valve 107 is attached to the first pipe L1 on the right end side with respect to the second connector 105.

FIG. 10B is shown a structure of the cell 103. The cell 103 comprises a first support member 111 and a second support member 113, which is arranged below facing the first support member 111. The first support member 111 is formed so that a flow channel 117, into which the introduction pipe 108 in FIG. 10A is communicated, penetrates it up and down. An O-ring 116, which plays a role as a gasket, is attached to an undersurface of the first support member 111 so as to surround an opening of the flow channel 117. The second support member 113 is formed so that a perforated plate 112 and a flow channel 118 penetrate it up and down from the upper side. A desalting membrane 114 and a filter paper 115 are arranged on the perforated plate 112 of the second support member 113 in this order. The desalting membrane 114 and the filter paper 115 are arranged between the flow channel 117 in the first support member 111 and the flow channel 118 in the second support member 113 by abutting an undersurface of the first support member 111 against an upper surface of the second support member 113 in this state and fixing them. Water, flowing in the flow channel 117 of the first support member 111, passes through the desalting membrane 114 and the filter paper 115, and flows in the perforated plate 112, and then is discharged from an outlet, which opens from a bottom of the flow channel 118 toward the outside of the second support member 113, thereby measuring the quantity of flow. In a blank test, the modified base material was not arranged in the cell. In each case, the modified base material was arranged to be in close contact with the surface of the support layer side of the osmosis membrane.

As shown in FIGS. 10A and 10B, in the test, pure water was poured into the cell 103 of the test apparatus 101 from the pump, and the pump, the first pressure-releasing valve 106 and the second pressure-releasing valve 107 were adjusted so that the osmotic pressure is 1 MPa. As the osmosis membrane, SWC 70, which is an RO membrane manufactured by Nitto Denko Corporation, was used. As the modified base material, the material manufactured in Example 1 was used. In each case, the test was carried out at 30° C. and a pressure of 3 mPa, and pure water was poured for 5 minutes. The weight of water dropped on the perforated plate after penetrating through the osmosis membrane and the modified base material was measured as the quantity of flow of water. The quantity of flow was expressed in the unit of gram.

The same test was repeated 3 times and the results are shown in TABLE 1.

TABLE 1

| | | Modified base |
|---|---|---|
| | | material of |
| | 70SWC alone | Example 2 |
| Quantity of | 7.933 | 8.57 |
| flow for | 7.926 | 8.61 |
| 5 minutes (g) | | |
| Average | 7.923 | 8.63 |
| quantity of | | |
| flow (g) | | |
| Ratio | 1 | 1.09 |

As compared to the case where only SWC 70 is used, a more quantity of flow was confirmed in the case where the modified base material is provided. From this result, it was clarified that when the modified base material manufactured in Example 2 is employed as the osmotic pressure inducer, the osmotic pressure can be enhanced. When the modified base material was disposed in contact with the osmosis membrane as the osmotic pressure inducer, the quantity of water penetrating the osmosis membrane was increased. From this result, it was suggested that the efficiency of the power generation can be improved in this manner.

In this test, fresh water was used on both sides of the osmosis membrane and the modified base material as the osmotic pressure inducer. The test results demonstrate that the salt structure present in the osmotic pressure inducer exhibits a net osmotic pressure enhancing effect.

### EXAMPLE 3

### Preparation of Modified Base Material

A modified base material to be used as an osmotic pressure inducer was prepared by the following synthesizing method.

### Synthesizing Method

(1) Preparation of Modified Base Material Using Aminosilane

### Reaction Condition 1

700 mg of silica gel (Davisil 12) and 1 g of aminosilane (3-aminopropylmethyldimethoxysilane) were added to 10 mL of pure water, and the mixture was stirred for 24 hours at room temperature. The resultant was filtrated to obtain a solid material. The solid material was added to 10 mL of 0.5%-hydrochloric acid and the resultant was stirred for 10 minutes at room temperature. After the reaction, the resultant was filtrated and washed with pure water, and thus a white solid matter was obtained. The obtained matter was used as the modified base material of the synthesizing method (1) in the test.

(2) Preparation of Modified Base Material Using Epoxysilane

30 mg (20.5g) of silica gel (Davisil 12) was added to 40 mL of acetone in an ice bath. After the temperature was set back to room temperature, 6 g of epoxysilane (3-glycidoxy propyltrimethoxysilane) was added thereto, and then acetone was removed with an evaporator (a bath temperature of 40° C.). After that, the resultant was dried for 24 hours at room temperature. The modified silica gel was put into 70 mL of pure water, and 32 g of sodium bisulfite was added thereto. The resultant was stirred all night at room temperature to obtain a solid material. The solid material was added to a 0.5% sodium hydroxide solution. The solution was stirred for 5 minutes at room temperature. After the reaction, the resultant was filtrated and washed with pure water, and thus a white solid matter was obtained. The obtained matter was used as the modified base material of the synthesizing method (2) in the test.

### Testing Method

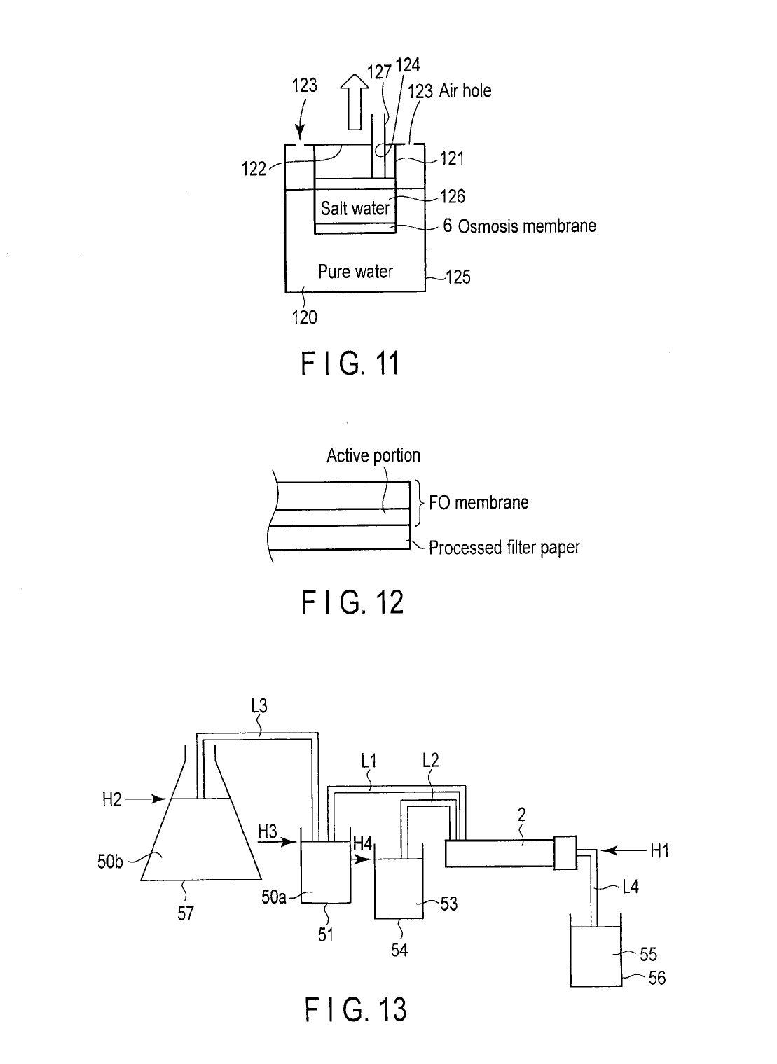

As shown in FIG. 11, a cylindrical acryl resin-made container 120 having a diameter of 84 mm and a height of 100 mm and an acryl resin-made cylinder 121 having a diameter of 50 mm and a height of 50 mm were prepared. Further, a cap 122, which can be attached to an opening of the container 120 and has two air holes 123 and two openings 124, was prepared. The air holes 123 are opened symmetrically with respect to the center of the cap 122 in a vicinity of an outer circumference of the cap 122.

First, one of the openings of the cylinder 121 was covered with an osmosis membrane 6. Then, pure water 125 was poured into the container 120, and the cylinder 121 was put in the container 120 and set therein such that the osmosis membrane is located at a lower end and immersed in the pure water. Next, salt water 126 was added into the cylinder 121, and the cap 122 is attached to the opening of the container 120 and the opening of the cylinder 121 was air-tightly closed as well. When the attachment of the cap 122 is completed, the two air holes 123 are located on an outer side with respect to the opening of the cylinder 121. After that, a rubber stopper (not shown) was attached to each of the two openings 124 of the cap 122 to air-tightly close. One of the rubber stoppers has a hole opened, through which a glass pipe 127 was put. As the container 120, the cylinder 121 with the lower end covered by the osmosis membrane 6, and the cap 122 were assembled as described above, a space above the pure water 125 in the container 120 is communicated with the atmosphere via the air holes 123 of the cap 122, and a space above the salt water 125 in the cylinder 121 is enclosed. With the above-describe structure, the quantity of water moving from the pure water side to the salt water side through the osmosis membrane 6 can be measured by monitoring the level of the salt water ascending in the glass pipe 127.

In this test, a 0.05%-sodium chloride aqueous solution was used as the salt water, and two of such apparatuses were manufactured. The two types of modified base materials already prepared were added respectively to the salt water of the apparatuses in amount of 2 g each. The diameter of the osmosis membrane was 35 mm and the temperature was 25° C. (room temperature). Further, the volume of the salt water was 50 mL and the volume of the pure water was 350 mL in each apparatus. Thus, the test was performed.

A comparative example was carried out under the same conditions except that the modified base material was not added.

The results are shown in TABLE 2.

TABLE 2

| | Quantity of water |
|---|---|
| Type of silica gel | permeated for |
| added | 60 min (g) |
| None | 0.520 |
| Unmodified silica | 0.515 |
| gel | |
| Synthesizing | 0.790 |
| method (1) | |
| Synthesizing | 0.775 |
| method (2) | |

When the modified base material was added, the quantity of water penetrated the osmosis membrane was increased as compared to the case of the comparative example. From this result, it is suggested that the quantity of water penetrating the osmosis membrane is increased and thereby the power generation efficiency is improved when the modified base material as the osmotic pressure inducer is brought into contact with the osmosis membrane.

### EXAMPLE 4

A high-pressure test was carried out by the same method as in Example 2 except that an FO membrane was used in place of the RO membrane. A modified base material prepared by the same method as that of Example 2 was used. Further, as shown in FIG. 12, the modified base material was brought into contact with an active layer of the FO membrane.

The results thereof are shown in TABLE 3.

TABLE 3

| | | | Membrane |
|---|---|---|---|
| | | Supply | surface |
| | | rate by | arrangement: |
| | | pump | Forward |
| | 4 MPa | 2 mL/min | direction |
| | Time sec/(drop) | | |
| | FO | Modified | Filter |
| | membrane | base | paper |
| 17° C. | alone | material | alone |
| Dropping time | 83 | 81 | 88 |
| (sec) | 85 | 78 | 87 |
| One drop: 80 μL | 85 | 77 | 92 |
| | — | 79 | 92 |
| Total | 253 | 315 | 359 |
| Average time | 84.3 | 78.8 | 89.8 |
| (sec) | | | |
| Flow rate | 0.949 | 1.016 | 0.891 |
| (μL/sec) | | | |
| Flow rate | 0.0034 | 0.0037 | 0.0032 |
| (L/h) | | | |
| Flow rate | 0.174 | 0.186 | 0.164 |
| (m/h) | | | |
| Ratio | 1 | 1.07 | 0.94 |

When the FO membrane was employed, the quantity of liquid penetrated the membrane was increased with the provision of the modified base material as in the case of the RO membrane. Thus, it is now clarified that with use of the modified base material manufactured in Example 2 as the osmotic pressure inducer, the osmotic pressure can be enhanced. From this result, it is suggested that the quantity of water penetrating the osmosis membrane is increased and thereby the power generation efficiency is improved when the modified base material as the osmotic pressure inducer is brought into contact with the osmosis membrane.

### EXAMPLE 5

With use of an element (CSM RE2012-100: a product of Woongjin of Korea) as in the method discussed in Example 1, the quantity of flow of the liquid following therein was measured.

FIG. 13 shows a simplified apparatus obtained by converting the osmotic pressure power generation apparatus described above and shown in FIG. 6 into a laboratory level. As the osmotic pressure generator 2, a Korean element was used. In this element, salt water was injected from the inlet of the element, where originally seawater is supposed to be injected, and fresh water was injected to the outlet, where originally fresh water is supposed to be collected. Thus, the volume of the liquid output from the outlet was measured. Fresh water 50a was contained in a beaker 51 serving as the first storage tank 51. Salt water 53 was contained in a beaker 54 serving as the second storage tank 54. In this example, such a model was assumed that the salt water 53 is drawn from directly the salt water supply source such as sea with a pipeline, and the salt water is supplied to the osmotic pressure generator (element) 2.

The beakers 51 and 54 were connected respectively to the inlets of the element 2 by silicon tubes L1 and L2, and thus fresh water 50a and salt water 53 contained therein were allowed to flow into the element 2. Fresh water 50b was reserved in a flask 57, which was assumed as a river to supply fresh water to the beaker 51 assumed as the first storage tank. The beaker 51 and the flask 57 were coupled with each other with a silicon tube L3. The liquid (salt water 55) output from the outlet of the element 2 was contained in a beaker 56 assumed as the third storage tank via a silicon tube L4. The salt concentration of the salt water 53 flowing out was 7% by weight. The beakers and the flask were not covered with caps, and the test was carried out in an open state.

In this test, a level H1 of the outlet of the element 2, surface levels H2, H3 and H4 of the liquids contained respectively in the flask 57 and beakers 51 and 54, and the quantity of water flowing out (the quantity of discharge water mL/sec) were adjusted by changing the heights of the surface levels H1 to H4 relatively to each other.

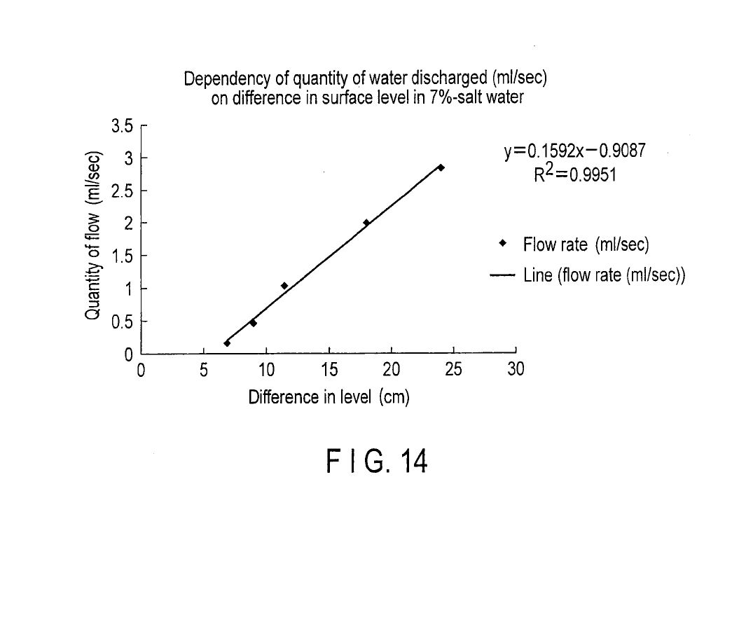

The results are shown in FIG. 14. The difference in level shown in FIG. 14 is a level difference between the surface level H4 and the surface level H1. The results indicate that how much influence can be caused on the quantity of flow of the liquid flowing out from the element 2 by the different between the surface level of the salt water of the salt water supply source (that is, the tide of the sea) and the level of the outlet of the element 2. For example, it can be understood that when the difference in level between the surface level H4 and the surface level H1 is 24 cm, the level difference can create 25 times as much as the quantity of flow as compared to the case where there is no difference in level, that is, they are at the equal level.

Or when the surface level H2 is higher than the surface level H1, a more water discharge in quantity was observed. Further, when the surface level H2 and the surface level H3 are equal and the surface level H4 is lower than the surface level H2, a more water discharge in quantity was observed. (The results of this are not particularly indicated here.)

From the results above, it can be understood that when the osmotic pressure generator (element) 2 is disposed such that the surface level of the fresh water contained in the first storage tank is equal to the surface level of the fresh water supply source such as a river to supply fresh water to the first storage tank, and the surface level of the seawater contained in the second storage tank is lower than the surface level of the level of the river and the level of the fresh water in the first storage tank, the water pressure of the fresh water supplied can be increased. Therefore, it is suggested that in this manner, a further efficient power generation can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An osmotic pressure power generation method comprising the steps of:
bringing fresh water and salt water to each other while interposing an osmosis membrane therebetween;
bringing an osmotic pressure inducer into contact with a salt water-side surface of the osmosis membrane to allow the fresh water to permeate at least the osmosis membrane by an osmotic pressure; and
rotating a rotor by a water pressure generated by the osmotic pressure, thereby generating power.

2. The method of claim 1, wherein the osmotic pressure inducer is a base material treated with a silane coupling agent.

3. The method of claim 2, wherein the base material is a membrane or a particle, and the silane coupling agent is aminosilane.

4. An osmotic pressure generator comprising:
an enclosed processing container;
an osmosis membrane configured to partition an inside of the enclosed processing container into a first chamber and a second chamber;
an osmotic pressure inducer brought into contact with a surface of the osmosis membrane, the surface of the osmosis membrane being faced the second chamber;
a first inlet formed on a first chamber side of the processing container and configured to flow fresh water into the first chamber;
a second inlet formed on a second chamber side of the processing container and configured to flow salt water into the second chamber; and
an outlet formed on a second chamber side of the processing container.

5. The generator of claim 4, wherein the osmotic pressure inducer is a membrane and disposed to be in contact entirely with the surface of the osmosis membrane, located on the second chamber side.

6. The generator of claim 4, wherein the osmotic pressure inducer is in a form of particles and dispersed in the salt water in the second chamber, and some of the particles are brought into contact with the surface of the osmosis membrane, located on the second chamber side.

7. The generator of claim 4, wherein the osmotic pressure inducer is a base material treated with a silane coupling agent.

8. The generator of claim 7, wherein the base material is a membrane or a particle, and the silane coupling agent is aminosilane.

9. The generator of claim 4, wherein the osmosis membrane is disposed vertically to a direction of gravity, and the second chamber is disposed higher than the first chamber.

10. The generator of claim 4, further comprising a first storage tank connected to the first inlet and configured to contain the fresh water, and a second storage tank connected to the second inlet and configured to contain the salt water.

11. The generator of claim 10, further comprising a first pipeline having one end connected to the first storage tank and another end to be set in a river, configured to supply fresh water from the river to the first storage tank,
wherein a surface level of the fresh water in the first storage tank is equal to an average surface level of the river, and
a surface level of the salt water in the second storage tank and a position of the outlet of the osmotic pressure generator are set lower than the average surface level of the river.

12. The generator of claim 10, further comprising a second pipeline having one end connected to the second storage tank and another end to be set in seawater, and a pump configured to supply the seawater as the salt water from the sea to the second storage tank.

13. The generator of claim 11, further comprising a second pipeline having one end connected to the second storage tank and another end to be set in seawater, and a pump configured to supply the seawater as the salt water from the sea to the second storage tank.

14. An osmotic pressure power generation apparatus comprising:
an osmotic pressure generator comprising:
an enclosed processing container,
an osmosis membrane configured to partition an inside of the enclosed processing container into a first chamber and a second chamber,
an osmotic pressure inducer brought into contact with a surface of the osmosis membrane, the surface of the osmosis membrane being faced the second chamber,
a first inlet formed on a first chamber side of the processing container and configured to flow in the fresh water into the first chamber,
a second inlet formed on a second chamber side of the processing container and configured to flow in the salt water into the second chamber, and
an outlet formed on a second chamber side of the processing container; and
a power generator comprising a rotor configured to rotate by flow of the salt water flowing out through the outlet of the processing container.

15. The apparatus of claim 14, further comprising a battery connected to the power generator and configured to store electrical power generated by the power generator.

16. An osmotic pressure power generation apparatus comprising:
an osmotic pressure generator comprising:
an enclosed processing container,
an osmosis membrane configured to partition an inside of the enclosed processing container into a first chamber and a second chamber,
an osmotic pressure inducer brought into contact with a surface of the osmosis membrane, the surface of the osmosis membrane being faced the second chamber,
a first inlet formed on a first chamber side of the processing container and configured to flow in the fresh water into the first chamber,
a second inlet formed on a second chamber side of the processing container and configured to flow in the salt water into the second chamber, and
an outlet formed on a second chamber side of the processing container;
a storage tank connected to the first outlet of the processing container and comprising a second outlet, the storage tank configured to contain salt water flowing out through the first outlet; and
a power generator comprising a rotor configured to rotate by flow of the salt water flowing out through the second outlet of the storage tank.

17. The apparatus of claim 16, further comprising a battery connected to the power generator and configured to store electrical power generated by the power generator.
